(19) United States
(12) Patent Application Publication
(10) Pub. No.: US 2025/0094712 A1
(43) Pub. Date: Mar. 20, 2025

(54) MULTI-GRANULAR CLUSTERING-BASED SOLUTION FOR KEY-VALUE CACHE COMPRESSION

(71) Applicant: Intel Corporation, Santa Clara, CA (US)

(72) Inventors: Gopi Krishna Jha, Mysore, Karnataka (IN); Sameh Gobriel, Dublin, CA (US); Nilesh Jain, Portland, OR (US)

(73) Assignee: Intel Corporation, Santa Clara, CA (US)

(21) Appl. No.: 18/965,267

(22) Filed: Dec. 2, 2024

(51) Int. Cl. G06F 40/284; G06F 16/28

(52) U.S. Cl. CPC G06F 40/284; G06F 16/285

(57) ABSTRACT

Key-value (KV) caching accelerates inference in large language models (LLMs) by allowing the attention operation to scale linearly rather than quadratically with the total sequence length. Due to large context lengths in modern LLMs, KV cache size can exceed the model size, which can negatively impact throughput. To address this issue, a multi-granular clustering-based solution for KV cache compression can be implemented. Key tensors and value tensors corresponding unimportant tokens can be approximated using clusters created at different clustering-levels with varying accuracy. Accuracy loss can be mitigated by using proxies produced at finer granularity clustering-level for a subset of attention heads that are more significant. More significant attention heads can have a higher impact on model accuracy than less significant attention heads. Latency is improved by retrieving proxies from a faster memory for a subset of attention heads that are less significant, when impact on accuracy is lower.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary large language model implemented as a transformer-based neural network, according to some embodiments of the disclosure.

FIG. 2 illustrates a serial transformer block, according to some embodiments of the disclosure.

FIG. 3 illustrates a parallel transformer block, according to some embodiments of the disclosure.

FIG. 4 illustrates an attention layer of a transformer block, according to some embodiments of the disclosure.

FIG. 5 illustrates computations in a self-attention layer without key-value (KV) caching, according to some embodiments of the disclosure.

FIG. 6 illustrates computations in a self-attention layer with KV caching, according to some embodiments of the disclosure.

FIG. 7 illustrates a multi-level memory system, according to some embodiments of the disclosure.

FIG. 8 illustrates a multi-level memory system having KV cache compression, according to some embodiments of the disclosure.

FIG. 9 illustrates different clustering-levels, according to some embodiments of the disclosure.

FIG. 10 is a flowchart illustrating KV cache retention and approximation using proxies, according to some embodiments of the disclosure.

FIG. 11 is a flow chart illustrating determination of significance of an attention head, according to some embodiments of the disclosure.

FIG. 12 is a flowchart illustrating a method for KV caching with multi-granular clustering-based approximation of KV caches associated with unimportant tokens, according to some embodiments of the disclosure.

FIG. 13 is a block diagram of an exemplary computing device, according to some embodiments of the disclosure.

### DETAILED DESCRIPTION

### Overview

The last decade has witnessed a rapid rise in artificial intelligence (AI) based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution operation, matrix multiplication operation, layer normalization operation, batch normalization operation, SoftMax operation, pooling operation, element-wise operation, linear operation, non-linear operation, and so on. While DNNs are effective at analyzing and predicting, they come at a cost of immense computational power. DNNs can consume significant power and runtime during training and during inference.

Transformer-based neural networks or transformer-based models are a type of DNN that can be used to power large language models (LLMs) and computer vision models (referred to in literature as ViTs). Transformer-based neural networks are used in services and applications such as natural language processing, speech processing, conversational AI assistants, image captioning, object detection, video understanding, recommendation systems, bioinformatics, time-series forecasting, reinforcement learning, and generative models to produce text, image, or music. Cloud companies can offer a transformer-based neural network as a hosted service, where the transformer-based neural network can be served by many distributed graphical processing units (GPU) workers, and the hosted service can service many requests for many users.

For some LLMs or other machine learning models, an autoregressive transformer-based neural network is used. The transformer-based neural network can generate one token at a time (e.g., one word at a time) based on an input prompt and the previous sequence of the output's tokens that the transformer-based neural network has generated so far. The process involving performing all the operations in the transformer-based neural network is repeated, token by token, until the transformer-based neural network outputs a termination token. A key-value (KV) cache is introduced to avoid redundant computations when generating tokens one at a time. Specifically, the KV cache allows cached key tensors and value tensors (attention outputs of the operations in the transformer-based neural network) from previous tokens to be reused. A KV cache stores precomputed key tensors and value tensors from the attention calculations and allows them to be reused when generating new tokens.

The cached key tensors and value tensors may include (intermediate) key tensors and value tensors generated in the attention mechanism (e.g., the one or more attention layers in a transformer-based neural network) during the process of producing previous output tokens of a request. Herein, a request refers to an instruction to a transformer-based neural network to generate one or more output tokens based on one or more input tokens. A request may include a request to a transformer-based neural network to generate one or more responses having one or more output tokens in response to an input prompt having one or more input tokens. The generation may involve autoregressive generation of tokens, where, to generate the next token involves using a generated token as part of the input tokens. A request can include or involve one or more tokens. The cached key tensors and value tensors can correspond to the one or more tokens. Using a KV cache to store the cached key tensors and value tensors can significantly reduce computation time and memory usage. The intermediate key tensors and value tensors may include key tensors and value tensors produced across layers and attention heads within a layer during the generation of a token.

Herein, input or output data of deep learning operations, such as the attention outputs or intermediate attention outputs of the attention mechanism in an attention layer, may be arranged in data structures called tensors. A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. The attention mechanism may produce attention outputs, such as key tensors and value tensors that correspond to one or more tokens, which can be cached in the KV cache to avoid redundant computations.

KV caching can accelerate inference in LLMs by allowing the attention operation to scale linearly rather than quadratically with the total sequence length. One important challenge for executing these transformer-based neural networks and serving many requests to the neural networks is the management of KV cache. Due to large context lengths in modern LLMs, KV cache size can exceed the model size, which can negatively impact throughput. Efficient use of the KV cache can reduce the cost of serving individual requests, increase throughput of the hosted service, and increase availability of the hosted service. The challenge can be present where the neural network is being executed with limited memory budget (as in most practical implementations) for the KV cache. Managing the KV cache is not trivial because KV cache size grows linearly with sequence length (each request can be huge). In some cases, the KV cache can require several times more memory than the memory used to store the model parameters.

Some solutions address this challenge by minimizing the memory footprint of the KV cache through techniques such as discarding/skipping low-attention tokens, quantization, and matrix approximation. In one group of approaches, tokens are retained based on the importance of tokens. In other words, important tokens, or a subset of tokens are retained in the KV cache. The importance refers to the importance of the token for the attention mechanism of the transformer-based neural network, or contribution of the token to the attention mechanism. In some cases, the importance can be determined based on attention weights, or distance from the current token, etc. Herein, when referring to retention of a token, it means that the KV cache (having cached key tensors and value tensors) corresponding to the token are retained and stored in the KV cache. When referring to discarding/dropping/evicting a token, it means that the KV cache (having cached key tensors and value tensors) corresponding to the token are not stored or kept in the KV cache. In another group of approaches, apart from retaining the important tokens, methods focus on retaining the less important tokens by introducing noise, apply matrix approximation, implement mixed-precision quantization, etc. These groups of approaches relate to KV cache compression, which aim to reduce the size of the KV cache. Compression techniques generally can suffer from accuracy loss, if not managed appropriately.

To address this issue, a multi-granular clustering-based solution for KV cache compression can be implemented. The solution retains the important tokens and applies a unique technique for managing the unimportant tokens. A key tensor and a value tensor corresponding an unimportant token can be approximated using centroids of clusters created at different clustering-levels with varying accuracy. Specifically, a key tensor and value tensor can be approximated using a centroid closest to the key tensor and value tensor among the centroids of the clusters (or a centroid of a cluster to which the key tensor or value tensor belongs). The centroid can serve as a proxy key tensor and a proxy value tensor for the unimportant token. The approximation can mitigate accuracy degradation due to compression. Furthermore, accuracy loss can be mitigated by using proxies produced at finer granularity clustering-level for a subset of attention heads that are more significant, since more significant attention heads can have a higher impact on model accuracy than less significant attention heads. In addition, a faster (and smaller) memory may store proxies generated at a coarser granularity (e.g., centroids generated using fewer number of clusters), and a slower (and bigger) memory may store proxies generated at a finer granularity (e.g., centroids generated using a greater number of clusters). Latency is improved by retrieving proxies produced using a coarser clustering-level from a faster memory for a subset of attention heads that are less significant, when impact on accuracy is lower.

Rather than checking or scanning each clustering-level to find the closest proxy key tensor and proxy value tensor to represent the computed key tensor and value tensor, the clustering-level at which the proxy key tensor and proxy value tensor are produced is (directly) determined based on a significance score of the attention head that computed the key tensors and value tensors. Specifically, the clustering-level is selected, chosen, or determined from a plurality of different clustering-levels using the significance score of the attention head. A significance score of an attention head can be measured based on how similar the input and the output of the attention head are. In one example, cosine similarity of the input and the output of an attention head can be used to determine the significance score of the attention head. The input may be the query tensor, and the output may be the output of the attention function. Different ranges of significance scores of attention heads can map to different clustering-levels at various granularity. The significance score of an attention head can thus be directly mapped to a specific clustering-level for retrieving a proxy, and the mapping enables the determination of the specific clustering-level to be done in one shot. The proxy key tensor and proxy value tensor for the attention head can be retrieved at the corresponding memory storing centroids of clusters produced according to the specific clustering-level. Using the significance score to determine the clustering-level at which the proxy key tensor and proxy value tensor are produced can avoid computations/iterations otherwise needed to find the closest proxies and allow for proxies to be retrieved quickly based on whether the accuracy loss will contribute greatly to the final accuracy of the transformer-based neural network.

The multi-granular clustering-based solution is hardware-aware. First, the different memories at various speeds/latencies and sizes are initially discovered to assess the resources available in the underlying memory hierarchy. One or more other factors/considerations may be determined, such as maximum sequence length, batch size, maximum of concurrent users of a system, maximum number of concurrent requests, tolerated accuracy loss, target inference latency, and/or desired throughput. A set of clustering-levels can be determined based on one or more factors, such as the available resources, and tolerated accuracy loss.

The multi-granular clustering-based solution can offer greater KV cache compression, increase LLM serving/inference throughput, and reduce inference latency. The hardware-aware approach enables the multi-granular clustering-based solution to efficiently utilize the underlying memory hierarchy. The multi-granular clustering-based solution can achieve a higher compression ratio for KV caches, which can result in improved inference throughput of LLMs as a hosted service. Moreover, the multi-granular clustering-based solution is compatible with other KV cache management techniques such as KV cache paging and quantization.

In some experiments, for ˜3% degradation in accuracy, it is possible to achieve ˜15× compression and ˜50% better inference latency using the multi-granular clustering-based solution.

In some experiments, the multi-granular clustering-based solution is able to achieve significant accuracy gains for state-of-the-art large language models with a fixed cache budget when evaluated on different use cases such as question and answering, and summarization.

In some experiments, inference latency, in particular the average memory access latency, when using the multi-granular clustering-based solution, can be significantly reduced by leveraging the cache hierarchy. Moreover, by using a greedy clustering/grouping algorithm, clustering overhead can be dramatically reduced when compared to solutions that implement a clustering technique that searches for the optimal clusters (e.g., k-means clustering).

Various embodiments described herein may be illustrated in the context of a specific architecture or implementation. It is envisioned that the teachings of the embodiments described herein may apply to other neural networks or models having an attention mechanism or an attention head where KV caching schemes may be employed to reduce computation.

Various examples of KV caching are described in the context of a multi-level memory system, or a multi-level cache system. It is envisioned that the teachings of the embodiments described herein can be applied to other variations or flavors of multi-level cache systems, or hierarchical caches. It is also envisioned that the teachings of the embodiments can applied to distributed computing systems/environments having multiple memories with different sizes and/or latencies. It is also envisioned that the teachings of the embodiments can applied to standalone computing systems having multiple memories with different sizes and/or latencies.

### Transformer-Based Neural Networks or Transformer-Based Models

Generative AI Models such as LLMs have taken the computing industry by storm. These models are armed with a gigantic number of parameters, exhibit exceptional state-of-the-art performance across various tasks. Current trends of LLM models are heading to scale of multi-trillion parameter models. According to one estimate, models are growing by 10× every 2 years. Current trajectory makes it practically impossible for smaller and medium players to operate and serve LLMs, and the sheer size of these models (one model requires 325 GB of memory simply to load its model weights) renders traditional optimization techniques like prefetching, dataflow, and caching completely ineffective. Furthermore, LLM during inference presents a tremendous challenge for the compute and memory resources (both bandwidth and capacity) for the platform. Additionally, the strict latency requirement (in the order of 50-100 ms), makes it more challenging to deliver high throughput while maintaining the latency.

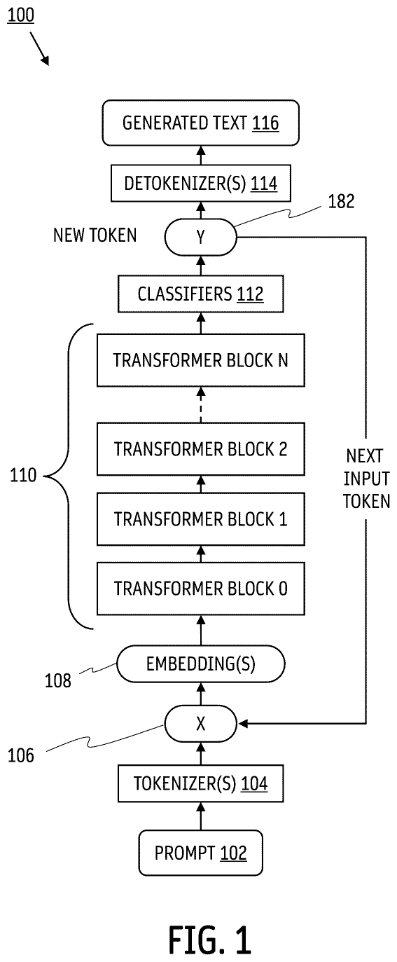

FIG. 1 illustrates an exemplary LLM 100 implemented as a transformer-based neural network, according to some embodiments of the disclosure. LLM 100 may include one or more components: tokenizer(s) 104, a stack of transformer blocks 110 (e.g., shown as transformer block 0, transformer block 1, transformer block 2, . . . Transformer N), one or more classifiers 112, and detokenizer(s) 114. Tokenizer(s) 104 can break input data (e.g., prompt 102) into tokens. For example, prompt 102 may include text and tokenizer(s) 104 may break prompt 102 into sub-words. One or more tokens, represented as X 106, may be converted into embedding(s) 108, which includes high-dimensional input features for the stack of transformer blocks 110. The stack of transformer blocks 110 can acquire knowledge about the input data.

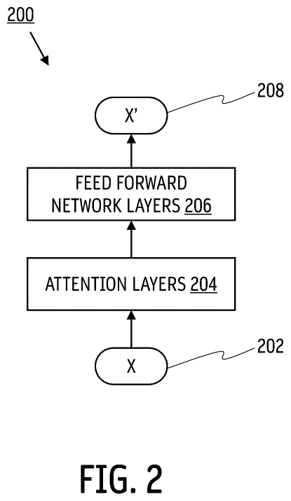

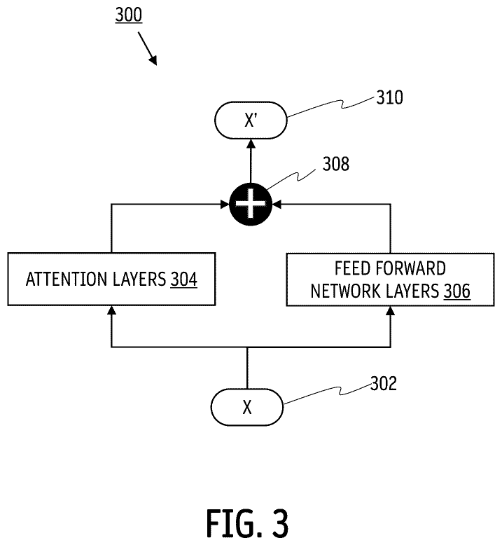

A transformer block in the stack of transformer blocks 110 can include two types of layers equipped with learning parameters: attention layers and feedforward (FFN) layers. One exemplary arrangement of a transformer block is illustrated in FIG. 2. Another exemplary arrangement of a transformer block is illustrated in FIG. 3. Attention layers allow the model to weigh the importance of tokens based on their contextual relevance and to capture their dependencies. Attention layers implement the attention mechanism of a transformer block, which captures contextual information by attending to positions within the sequences. FFN layers provide non-linear transformations to tokens independently.

One or more classifiers 112 can produce predictions or generate tokens based on the learned representations of the stack of transformer blocks 110. The tokens may be used by one or more detokenizer(s) 114 to produce generated text 116.

LLM 100 can serve as a framework for modeling complex relationships in text, images, audio, video, point clouds, graphs, etc. The number of learning parameters can be scaled up using the framework to model even more complex relationships.

LLM 100 is formulated to model sequential text in an autoregressive manner. Each subsequent token, shown as Y 182, is determined by the context of preceding tokens. During the training process of LLM 100, the transformer architecture is tasked to learn to predict the next token, Y 182, through slices of text with known succeeding tokens. Leveraging the abundance of text data available on the Internet, the size of transformers can be scaled up tremendously to hundred-billions of parameters. LLM 100 may be known as autoregressive transformer, causal transformer, decoder-only transformer, and decoding transformer. Subsequent alignment stage can make LLM 100 converse contextually and to human preference. A conversational LLM involving LLM 100 can be referred to as a Generative Pre-trained Transformer (GPT). Aligned LLMs may be known as instruction-tuned, instruction-following, and supervised fine-tuned LLMs.

Autoregressive modeling entails a sequential prediction during its deployment, hence LLM-based applications involve, by and large, text generation, outputting a token after token. The autoregressive nature of the model means engaging the whole model structures for every token prediction. Attributed to the vast number of model parameters (currently reaching scale of billions), the sequence inference is computationally demanding, characterized by an initial compute-intensive first prediction, followed by subsequent token-to-token predictions that are bottlenecked by memory bandwidth. The attention layers computation complexity is quadratic with the sequence length. Such complexity severely bottlenecks the performance especially for longer sequences.

FIG. 2 illustrates serial transformer block 200, according to some embodiments of the disclosure. Serial transformer block 200 includes attention layers 204, and FFN layers 206. An input, X 202, is first processed by attention layers 204, and the output of attention layers 204 is passed to FFN layers 206. FFN layers 206 may produce output, X′ 208. In some cases, serial transformer block 200 may include a skip connection that passes the input, X 202, to be added the output, X′ 210. Serial transformer block 200 may be implemented as one of the transformer blocks of the stack of transformer blocks 110 in FIG. 1.

FIG. 3 illustrates parallel transformer block 300, according to some embodiments of the disclosure. Parallel transformer block 300 includes attention layers 304, and FFN layers 306. An input, X 302, is processed by attention layers 304, and the input, X 302, is processed (in parallel) by FFN layers 306. The output of attention layers 304 and the output of FFN layers 306 are combined at adder 308. Adder 308 may produce a sum of its inputs, e.g., the output of attention layers 304 and the output of FFN layers 306. Adder 308 may produce a weighted sum of its inputs, e.g., the output of attention layers 304 and the output of FFN layers 306. Adder 308 may produce output, X′ 310. In some cases, parallel transformer block 300 may include a skip connection that passes the input, X 302, to be added to the output, X′ 310. Parallel transformer block 300 may be implemented as one of the transformer blocks of the stack of transformer blocks 110 in FIG. 1.

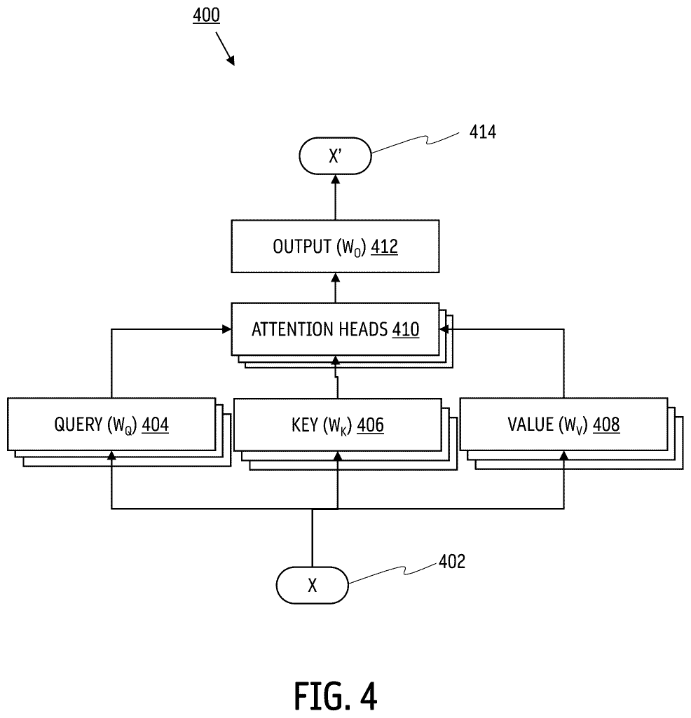

As illustrated in FIG. 1, transformer-based neural network models rely on encoder-decoder stacks with identical layers. As illustrated in FIGS. 2-3, each layer can have two key components: self-attention and feedforward networks. Self-attention allows the model to analyze the entire sequence at once, but a single mechanism might miss nuances. Multi-head attention addresses this by creating multiple independent “heads” that focus on different aspects of word relationships. Multi-head attention mechanism is illustrated in FIG. 4. The outputs from these heads are combined for a richer understanding. Feedforward networks complement self-attention by introducing non-linearity, enabling the model to learn complex patterns. The number of layers stacked in the encoder and decoder (depth) and the number of heads within each layer (width) are hyperparameters. More layers and heads can enhance the model's ability to capture long-range dependencies but increase complexity. Heads and layers of various transformer blocks, work together to give LLMs a nuanced grasp of text data, leading to superior performance natural language processing tasks.

FIG. 4 illustrates attention layer 400 of a transformer block, according to some embodiments of the disclosure. Attention layer 400 may be included as part of a transformer block in the stack of transformer blocks 110 in FIG. 1. As an example, attention layer 400 illustrates a multi-head attention layer having multiple attention head mechanisms. The input, X 402, be converted into queries (Q), keys (K), and values (V). Attention layer 400 includes parallel linear projections 404 of queries using the query weight matrix W_{Q}. Attention layer 400 includes parallel linear projections 406 of keys using the key weight matrix W_{K}. Attention layer 400 includes parallel linear projections 408 of values using the value weight matrix W_{V}. Results of linear projections are provided to parallel attention heads 410. An attention head 410 may apply an attention function using an output from one of the linear projections 404, an output from one of the linear projections 406, and an output from one of the linear projections 408. The attention function can be defined as:

$$Attention ( Q , K , V ) = SoftMax ( \frac{{QK}^{T}}{{d}_{k}} ) V \qquad ( eq . 1 )$$

Q in equation 1 represents an output from one of the linear projections 404. K in equation 1 represents an output from one of the linear projections 406. V in equation 1 represents an output from one of the linear projections 408. dₖ represents a scaling factor. An attention head 410 may compute

$$\frac{Q {K}^{T}}{{d}_{k}}$$

to produce a matrix of raw attention scores based on the queries and keys. An attention head 410 may compute

$$SoftMax ( \frac{Q {K}^{T}}{{d}_{k}} )$$

to produce a matrix of attention weights, having a normalized matrix of the raw attention scores. An attention head 410 may compute

$$SoftMax ( \frac{Q {K}^{T}}{{d}_{k}} ) V$$

to produce a final output where the attention weights are weighted by the values to form a final attended representation.

Outputs of parallel attention heads 410 may be concatenated together and passed to linear projection 412 using an output matrix W_{O}. The output of linear projection 412 is the output, X′ 414, of attention layer 400.

A linear projection used in attention layer 400 may include multiplying an input to the linear projection with a learned weight matrix. In some cases, the matrix multiplication is followed by an optional non-linearity, such as an activation function.

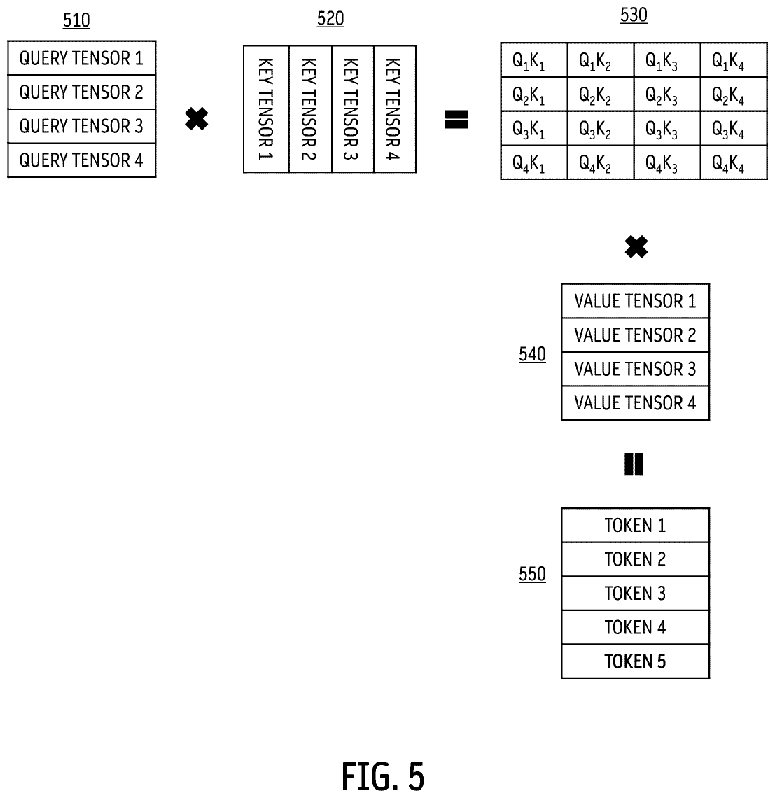

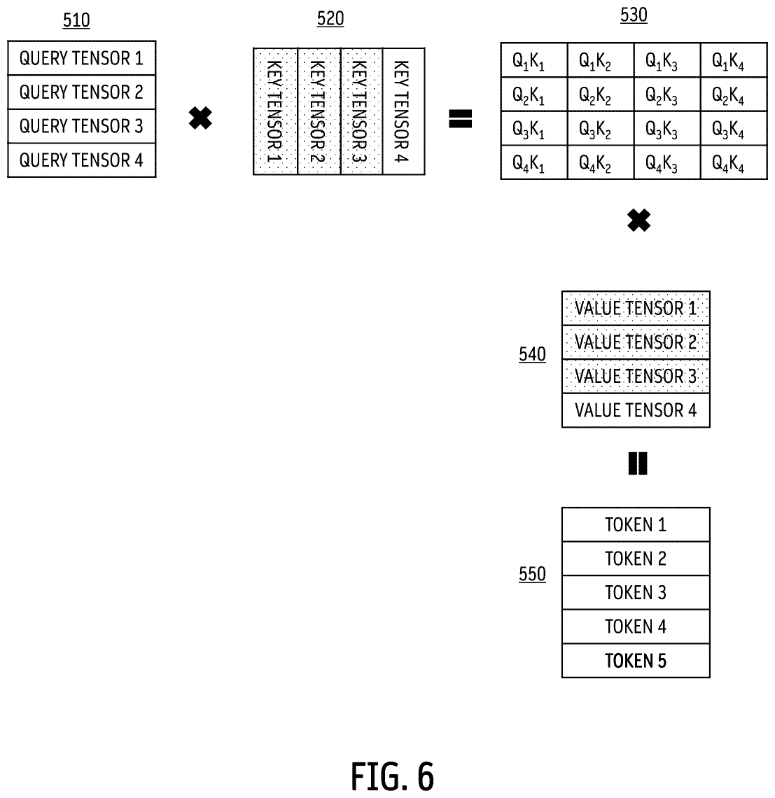

As discussed with FIG. 1, the attention mechanism in an autoregressive transformer-based model is a big bottleneck for performance for long sequences. A KV cache can be provided to store previously computed key tensors and value tensors from the attention mechanism and reuses the cached key tensors and value tensors for generating current tokens, and thus avoids intensive recalculations of the key tensors and value tensors for previous tokens. KV caching became the de-facto optimization of the inference process to accelerate generation throughput for LLMs, allowing the attention operation to scale linearly rather than quadratically in the total sequence length. FIGS. 5 and 6 contrasts computations in an attention layer without KV caching and with KV caching.

### Understanding KV Caching

FIG. 5 illustrates computations in a self-attention layer without KV caching, according to some embodiments of the disclosure. The self-attention layer may be part of a multi-head self-attention layer. In some embodiments, the self-attention layer is in a decoder of a transformer. In some embodiments, the self-attention layer may be in a transformer block, such as transformer blocks illustrated in FIG. 1. The computations in the self-attention layer may include multiplication of a query matrix 510 and a key matrix 520 (having one or more key tensors), which results in an attention weight matrix 530. The computations in the self-attention layer also includes multiplication of the attention weight matrix 530 and a value matrix 540 (having one or more value tensors), which results in an output matrix 550 encoding new tokens, such as token 5. In some cases, output matrix 550 may include a context-aware attention representation that is weighted by value matrix 540. Output matrix 550 may be produced by the attention layer according to equation 1, using query matrix 510, key matrix 520, and value matrix 540, from which one or more new tokens can be generated. In other embodiments, the computations in the self-attention layer may include other computations, such as computations with a scaling function, SoftMax function, and so on. For the purpose of simplicity and illustration, these computations are not shown in FIG. 5.

Each of the query matrix 510, key matrix 520, and value matrix 540 may include a tensor (e.g., vector) for each of the tokens in the input sequence. For the purpose of illustration and simplicity, the input sequence has four tokens: tokens 1-4. The query matrix 510 may include four query tensors produced based on the four input tokens: query tensors 1-4. The key matrix 520 may include four key tensors: key tensors 1-4. The value matrix 540 may include four value tensors: value tensors 1-4. In the embodiments of FIG. 5, as the decoder does not implement KV caching, computations to produce the key tensors in the key matrix 520 and all the value tensors in the value matrix 540 need to be conducted. Some of the computations have already been conducted in the previous inference phase, e.g., computations to produce the key tensors 1-3 and computations on the value tensors 1-3. The duplication of these computations can be a waste of computational resources, such as power, time, and so on.

FIG. 6 illustrates computations in a self-attention layer with KV caching, according to some embodiments of the disclosure. Different from the embodiments of FIG. 5, the decoder in FIG. 6 implements KV caching. With KV caching, the key tensors and value tensors computed in the previous inference phase(s) (e.g., key tensors and value tensors corresponding to tokens 1-3) are cached in a KV cache and can be reused in the current inference phase. A KV cache stores previously computed key tensors and value tensors computed for one or more tokens in the attention mechanism and reuses them for generating the next attention output or token. In an implementation where distributed GPU workers are executing operations of a neural network, the KV cache can be allocated in GPU memory and contents of the KV cache can be loaded from central processing unit (CPU) memory. In an implementation where a processor is executing operations of a neural network, the KV cache can be allocated in one or more memories local to the processor. The execution time scales more gracefully when KV caching is used as the sequence length increases. For instance, the generated intermediate KV tensors corresponding to previous tokens can be stored in a KV cache.

In the current inference phrase illustrated in FIG. 6, the cached key tensors and value tensors can be retrieved from a KV cache. Data that can be retrieved from the KV cache is highlighted with a dotted pattern in FIG. 6. Key tensors 1-3 may be retrieved from the KV cache. Value tensors 1-3 may be retrieved from the KV cache. In the current inference phase, the query matrix 510 can be multiplied with a concatenation of key tensor 4 and cached key tensors 1-3, followed by a SoftMax of the entire raw attention scores. The attention weights produced by performing SoftMax of the raw attention scores can be further multiplied with a concatenation of value tensor 4 and cached value tensors 1-3 to generate new results. After the inference is completed, key tensor 4 added to the KV cache. In some cases, the key tensors 1-3 can be updated in the KV cache. Also, value tensor 4 is added to the KV cache. In some cases, the value tensors 1-3 can be updated in the KV cache. This process is repeated per token. KV caching can reduce the number of computations in the self-attention layer. The amount of computation is reduced significantly when cached key tensors and value tensors can be reused to generate the next token. Therefore, computational resources can be saved. The performance and efficiency of the transformer model can be improved through KV caching.

When the KV cache is used, the previously computed key-value tensors are stored in memory (e.g., the KV cache) to avoid repetitive key-value projection computation in the attention mechanism, as illustrated in FIG. 6. The total memory footprint for a KV cache instance can be easily computed using equation 2:

$$Size = 2 \times precision \times {n}_{layers} \times {d}_{model} \times {L}_{sequence} \times B \qquad ( eq . 2 )$$

precision is the number of bytes per value stored (e.g., B for FP32), n_{layers} represents the number of layers in the model, d_{model} represents the dimensionality of the embeddings, L_{sequence} is the length of context in tokens, B is the batch size and the factor two is applied because two matrices for keys (K) and values (V) are needed.

As shown in equation 2, the KV cache size scales linearly with the (maximum) sequence length in the input context and the batch size. In practice, the size for the KV cache can be enormous. For example, a 175 billion parameters transformer-based model can consume around 325 GB of memory for storing the parameters. At the same time, at batch size 128 and sequence length 8K, the KV cache can have a size of around 4608 GB of memory, which is several orders of magnitude (12×) larger than the model weights themselves. Since the total sequence length cannot be known ahead of time, the KV cache memory requirements are therefore unknown, and this makes LLM memory management particularly challenging. Typically, the maximum sequence length (usually, 4K, and growing rapidly) is used for memory allocation to host the KV cache which leads to severely fragmented memory and very low batch size, and as a result, a low number of concurrent users for an LLM service is feasible.

The problem of the size of the KV cache is becoming increasingly prominent and is one of the key factors that makes LLM model deployment very costly. It is challenging to reduce KV cache memory footprints in LLMs without accuracy drops. With scaling sequence length becoming a critical demand for many companies, this makes limiting the context sequence inconceivable. The only design knob available for scaling a sizeable LLM deployment according to equation 2 is the batch size (B). Reducing batch size in effect reduces the model throughput, which as a result, severely degrades the total number of requests per second the model can serve.

### Related Work in KV Cache Compression

As discussed above, deployment of LLMs in generating long-context tokens is challenged by high memory demands. This is primarily due to the need to store all previous tokens in the attention module, resulting in a substantial memory footprint of the KV cache. Some methods achieve smaller memory footprint for KV cache using approaches such as token pruning and approximation of the KV cache.

Token pruning approaches prioritize the retention of a subset of tokens deemed crucial for the attention mechanism. The significance of these tokens is typically determined by factors such as attention weights, or their proximity to the current token. In some approaches, the methods focus on retaining only a select subset of tokens that contribute the most for the attention mechanism. The selection of the tokens can be based on the attention weights (which indicates their contribution), or their proximity to the current token being processed. Some methods leverage the observation that a small portion of tokens contributes the most value when computing attention scores/weights. Some methods are based on the observation that the importance of tokens decreases exponentially with increasing distance from the current token. Some token-dropping approaches to address this issue focus on eliminating tokens deemed unimportant for the attention algorithm, based on attention weights or distance from the current token, among other factors. However, these approaches often suffer from a lack of accuracy, even with moderate reductions in the number of tokens.

Techniques that approximate key tensors and value tensors aim to preserve all tokens through various strategies, including matrix approximation, mixed-precision quantization, etc. In some approaches, the methods retain KV caches corresponding to the important tokens, and strategically manage the KV caches corresponding to the less important ones. Some methods can include techniques such as: adding controlled noise, approximating large matrices with smaller ones, and reducing the precision of data representation (mixed-precision quantization). One method introduces Gumbel noise to retain a diluted version of the unimportant tokens. One method employs mixed-precision quantization to reduce the memory footprint of non-important tokens. One method employs utilizes low-rank matrix approximation.

### Multi-Level Memory System

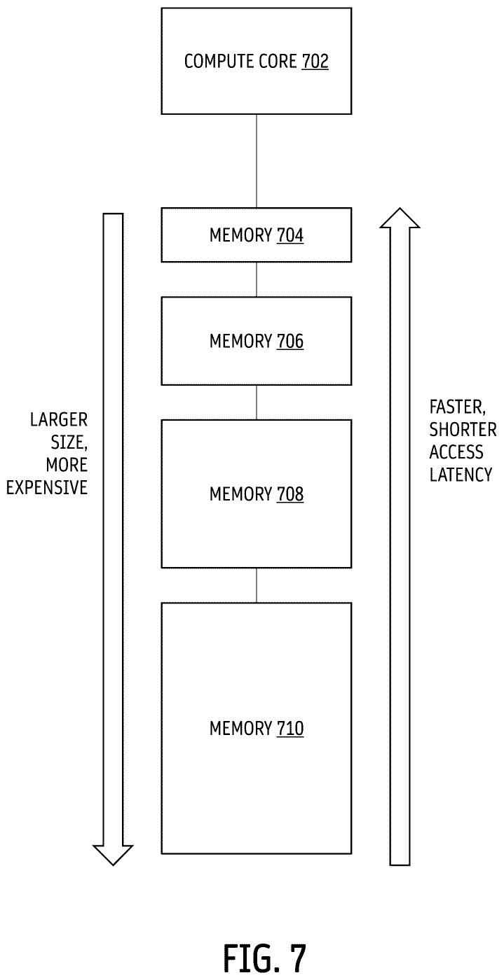

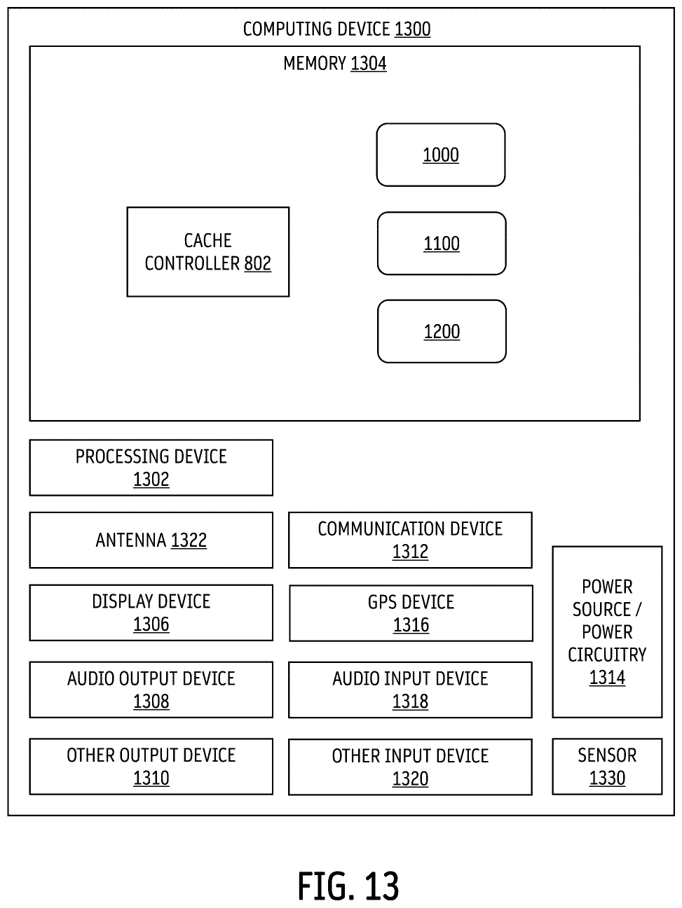

FIG. 7 illustrates a multi-level memory system, according to some embodiments of the disclosure. Compute core 702 may be communicably coupled to a plurality of (non-transitory computer-readable) memories, e.g., memory 704, memory 706, memory 708, memory 710, etc. Compute core 702 may be an example of processing device 1302, and the memories may be an example of memory 1304 of FIG. 13. Compute core 702 may include a computing processor or computing logic that processes a request to generate one or more tokens based on one or more input tokens. Compute core 702 may execute instructions to carry out one or more operations or calculations of a transformer-based neural network, such as computing the attention function for the attention mechanism of the transformer-based neural network. The memories may store data to be used by compute core 702 to carry out the one or more operations. The memories may store data computed by compute core 702 when carrying out the one or more operations. The data can include the KV cache. The KV cache can include one or more cached key tensors and one or more cached value tensors corresponding to one or more tokens. The memories may store a KV cache and provide cached key tensors and cached value tensors to compute core 702 to speed up processing of the attention mechanism by avoiding redundant calculations and reusing previously computed key tensors and value tensors.

The memories may be used to store data (in some cases instructions) to be used by compute core 702. The memories may be arranged as a hierarchy of memories, or a multi-level memory system. The multi-level memory system is designed to balance speed/latency, cost, and capacity. The hierarchy may be arranged from fastest/smallest/most expensive to slowest/largest/least expensive. In the example shown, memory 704, memory 706, memory 708, and memory 710 arranged from fastest/smallest/most expensive to slowest/largest/least expensive. The fastest/smallest/most expensive memories may include static random access memories (SRAMs). The slowest/largest/least expensive memories may include dynamic random access memories (DRAMs). For instance, memory 704, memory 706, and memory 708 may be SRAMs, and memory 710 may include DRAMs. In some scenarios, memory 704, memory 706, and memory 708 may be the L1 cache, L2 cache, and L3 cache operating to bridge the gap between compute core 702 and memory 710 operating as the main memory. The sizes/capacities of the memories and latencies of the memories may increase progressively from memory 704 to memory 710 onwards.

### Hardware-Aware KV Cache Compression

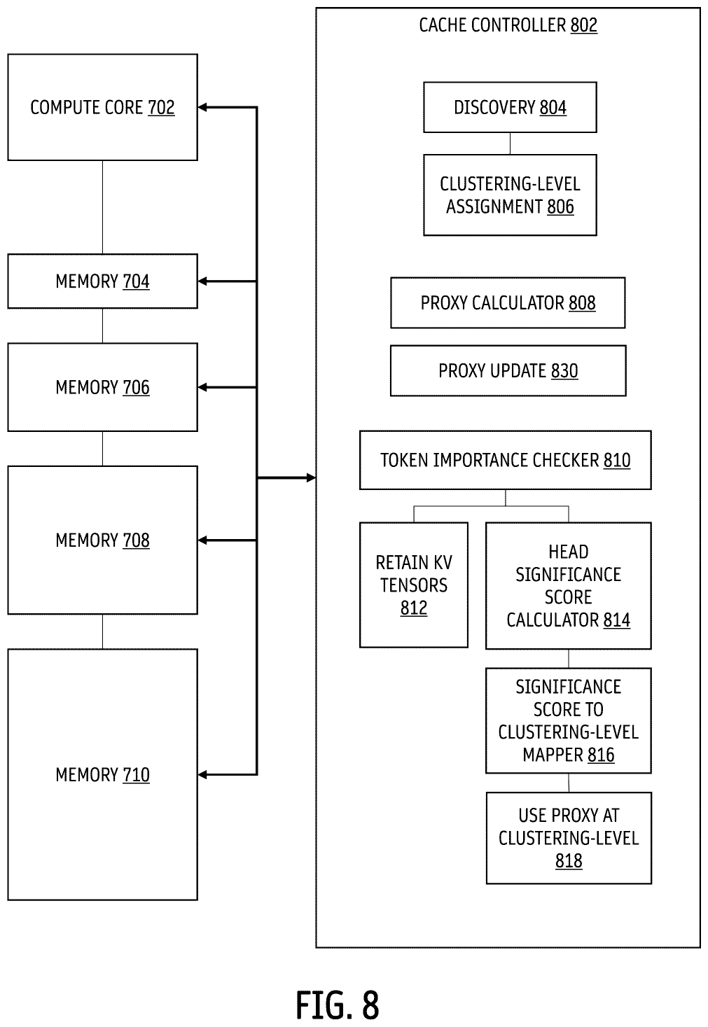

FIG. 8 illustrates a multi-level memory system having KV cache compression, according to some embodiments of the disclosure. Cache controller 802 can be implemented on compute core 702, or on a separate computing processor that is communicably coupled to the memories, e.g., memory 704, memory 706, memory 708, and memory 710. Cache controller 802 may control what data is retained/stored in the individual memories in a hardware-aware manner. Cache controller 802 may control what data is evicted in the individual memories. Cache controller 802 may control utilization of the memories. Cache controller 802 may implement a KV cache on the memories such that cached key tensors and cached value tensors can be provided to compute core 702. Cache controller 802 may implement one or more memory management techniques, such as KV cache compression, to efficiently utilize the memories.

Cache controller 802 may include discovery 804 and clustering-level assignment 806. Discovery 804 can provide information to clustering-level assignment 806 to determine appropriate clustering-levels for the different memories in the hierarchy. Discovery 804 and clustering-level assignment 806 can be implemented to better exploit the memory hierarchy (having different memory levels with varying sizes and access latencies) in the underlying hardware as illustrated in FIG. 7. Clustering-level assignment 806 can tune a design knob by setting the clustering-levels for the memories that enables the trade-off between accuracy and latency. Herein, clustering-level may define the granularity of clusters, and/or define the number of clusters to create when clustering.

Discovery 804 can discover the capabilities of the different memories. Discovery 804 can determine the various speeds/latencies and/or sizes, and a number of memories available to store the KV cache. Discovery 804 may also determine other factors/considerations, such as maximum sequence length, batch size, maximum of concurrent users of a system, maximum number of concurrent requests, tolerated accuracy loss, target inference latency, and/or desired throughput. Discovery 804 may discover one or more factors/considerations that may impact how to best utilize the memories.

Clustering-level assignment 806 can determine a cache budget for retaining important tokens, e.g., based on the one or more factors/considerations determined by discovery 804. Clustering-level assignment 806 can determine a plurality of cache budgets for storing proxy key tensors and proxy value tensors for unimportant tokens, e.g., based on the one or more factors/considerations determined by discovery 804. A higher cache budget can be set for a memory that is storing one or more centroids or representatives of clusters produced at a finer granularity clustering-level. A lower cache budget would be set for a memory that is storing one or more centroids or representatives of clusters produced at a coarser granularity clustering-level. Cache budgets may be dictated by the available resources of the underlying hardware. The cache budget for storing proxy key tensors and proxy value tensors is directly related to the clustering-level, which dictates the number of clusters to create during the clustering process and the number of centroids/proxies to store in a given memory.

Clustering-level assignment 806 can determine a set of clustering-levels, e.g., C clustering-levels, by optimizing for performance while satisfying the one or more factors/considerations. In some cases, the clustering-level is directly dependent on the cache budget allotted for a given memory. C may be a tunable parameter. C may be determined based on the depth of the memory hierarchy in the underlying hardware (discovered by discovery 804). C clustering-levels may include: clustering-level 1, clustering-level 2, clustering-level 3, . . . clustering-level C, etc. The set of clustering-levels may include a clustering-level per memory to be used to store data for the KV cache. The set of clustering-levels may include different clustering-levels from the coarsest granularity to the finest granularity. Granularity of clustering may become finer from level 1 to level C. Finer granularity means more clusters are produced. The granularity of a clustering-level has a direct impact on how much capacity is needed on a memory because coarser granularity means fewer clusters are produced, and finer granularity means more clusters are produced. Fewer clusters means that fewer centroids or representatives serving as proxies are retained/stored in a memory and higher KV compression. More clusters mean that more centroids or representatives serving as proxies are retained/stored in a memory and lower KV compression. The granularity of a clustering-level has a direct impact on the accuracy of the proxies because coarser granularity means that the proxies are more likely to serve as a better approximation, and finer granularity means the proxies are less likely to serve as a better approximation.

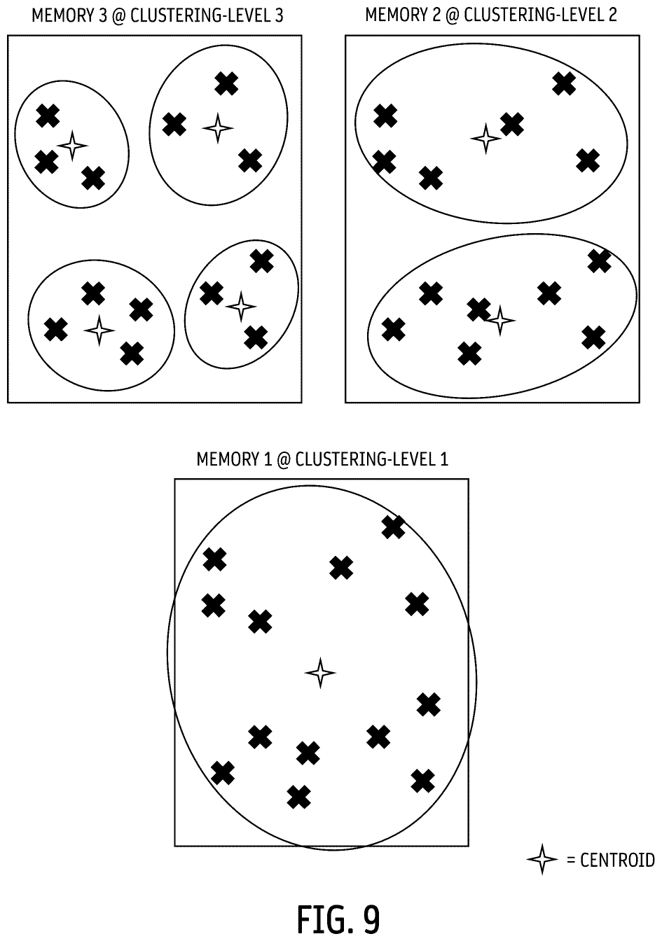

Referring briefly to FIG. 9, which illustrates different clustering-levels in a set of clustering-levels, clustering-level assignment 806 of FIG. 8 can assign a clustering-level to a memory, or a set of clustering-levels to memories arranged from the fastest/smallest to the slowest/largest. The example depicted has three clustering-levels: clustering-level 1, clustering-level-2, and clustering-level 3. Clustering-level 1 has the coarsest granularity (showing just one cluster), clustering-level 2 has finer granularity (showing two clusters), and clustering-level 3 has the finest granularity (showing four clusters). The underlying hardware in this example may include three memories in the hierarchy, shown as memory 1, memory 2, and memory 3. Memory 1 may be the fastest/smallest memory. Memory 2 may be the slower/larger memory. Memory 3 may be the slowest/largest memory. Referring back to FIG. 8, clustering-level assignment 806 of FIG. 8 can assign clustering-level 1 to memory 1, clustering-level 2 to memory 2, and clustering-level 3 to memory 3. Each memory, even though they correspond to different clustering-levels, stores proxies or representatives for all tokens. Any one of the memories can be used for fetching a proxy or representative for a token. The memories may correspond to unimportant tokens. Compression occurs in these memories because the originally computed key tensors and value tensors are not retained in the memories, and only the proxies or representatives are retained in the memories. Clustering-level with a finer granularity provides better approximation but at the cost of less KV compression.

Referring back to FIG. 8, clustering-level assignment 806 may determine the suitable clustering-level based on the capacities of the memories, so that the proxy key tensors and the proxy value tensors can be designed to fit in the respective memories. Using this clustering-level assignment, the KV cache is compressed at different compression levels. The key tensors and the value tensors would be clustered at the different granularities with varying levels of accuracies.

Clustering-level assignment 806 may assign one or more memories in the hierarchy (e.g., smaller/faster memories) to store proxy key tensors and proxy value tensors corresponding to the unimportant tokens.

Clustering-level assignment 806 may assign one of memories in the hierarchy (e.g., a largest/slowest memory) to store key tensors and value tensors corresponding to the important tokens. The memory may correspond to the important tokens. The memory may have “no clustering” as the clustering-level.

Proxy calculator 808 may determine the proxies or representatives to be stored in the memories at different clustering-levels. Proxy calculator 808 may evaluate the key tensors and the value tensors for all the tokens and perform clustering at the different clustering-levels. The technical task of proxy calculator 808 is to determine or select a proxy or representative for a group of tokens that offers an approximation of the key tensors and the value tensors corresponding to the group of tokens. Using a proxy or representative means that the KV cache can avoid having to store all the key tensors and value tensors for the entire group of tokens. The proxy key tensor and the proxy value tensor can thus serve as an approximation of the originally computed key tensor and the value tensor. Proxy calculator 808 can determine one or more proxy key tensors and one or more proxy value tensors based on clusters produced at a particular clustering-level and store the one or more proxy key tensors in the memory to which the particular clustering-level is assigned.

In some embodiments, proxy calculator 808 may group the key tensors and value tensors into one or more clusters according to a particular clustering-level, so that similar key tensors and value tensors corresponding to a group of tokens are grouped together. Proxy calculator 808 may perform clustering or grouping of the key tensors and value tensors to produce clusters corresponding to different groups of tokens. A suitable clustering algorithm that is suitable for a high-dimensional vector can be used to spatially gather groups of similar tensors. One example is a k-means clustering algorithm. Another example is Density-Based Spatial Clustering of Applications with Noise (DBSCAN). In some cases, a greedy clustering or grouping algorithm may be used by proxy calculator 808 to produce reasonable clustering results based on one or more heuristics. A greedy clustering or grouping algorithm may involve (randomly) selecting a center point as a center of a cluster, and iteratively evaluate all the points to add a further center point as a center point of a further center of a further cluster using a point that is furthest away from an existing center point until all the required number of center points are set. Once clusters are produced, proxy calculator 808 may select or calculate a proxy using the cluster corresponding to a group of tokens. A centroid of a cluster corresponding to a group of tokens can be calculated and used as the proxy or representative that can approximate the key tensors and value tensors corresponding to the group of tokens. A key tensor and a value tensor that is closest to the centroid of a cluster corresponding to a group of tokens can be selected and used as the proxy or representative that can approximate the key tensors and value tensors corresponding to the group of tokens. A key tensor and a value tensor in a cluster corresponding to a group of tokens can be randomly selected and used as the proxy or representative that can approximate the key tensors and value tensors corresponding to the group of tokens.

In some embodiments, proxy calculator 808 may cluster one or more key tensors and one or more value tensors according to the different clustering-levels. Proxy calculator 808 may determine the proxy key tensor and the proxy value tensor using one or more clusters at a given clustering-level. For example, proxy calculator 808 may determine the proxies based on one or more centroids of one or more clusters at the given clustering-level. The proxies may be determined for each clustering-level. Proxy calculator 808 may store the proxy key tensor and the proxy value tensor in a memory that corresponds to the given clustering-level, e.g., a memory assigned by clustering-level assignment 806 to store proxies generated at the given clustering-level. When the processor executing one or more operations of a neural network is generating one or more next tokens, the proxy key tensor and the proxy value tensor can be provided to the processor to facilitate reuse.

Proxy update 830 may be implemented to update the proxies or representatives stored in the memories, when new key tensors and new value tensors for new tokens are produced (e.g., by compute core 702 through the autoregressive process) and added to the KV cache. Proxy update 830 may perform a re-clustering or re-grouping of the tokens, using a suitable algorithm, to form new clusters corresponding to different groups of tokens. In some cases, to avoid re-clustering or re-grouping (which can be computationally expensive), proxy update 830 may compare the distances of the new key tensor and the new value tensor to the existing proxies or representatives to determine whether new key tensor and the new value tensor belongs to an existing cluster. The distances may be compared against a threshold. If a distance to an existing proxy/representative is below the threshold, the new key tensor and the new value tensor may belong to an existing cluster that is represented by the existing proxy/representative. If a distance to an existing proxy/representative is above a threshold, the new tensor and the new value tensor may not belong to an existing cluster that is represented by the existing proxy/representative. If the new key tensor and the new value tensor do not belong to an existing cluster (or any existing clusters), the new key tensor and the new value tensor may form its own new cluster and can be used as the proxy/representative of the new cluster. If the new key tensor and the new value tensor belong to an existing cluster (or at least one existing cluster), an existing proxy or representative representing the existing cluster may become the proxy or representative for the new key tensor and the new value tensor. If appropriate, the proxy or representative of the existing cluster may be updated based on the new key tensor and the new value tensor (e.g., the centroid of the cluster may be moved towards the new key tensor and the new value tensor). In some embodiments, the distances of the new tensor and the new value tensor to the existing proxies or representatives may be compared against a threshold to determine whether the new key tensor and the new value tensor belongs to an existing cluster. If a distance does not cross the threshold (e.g., the distance is smaller than the threshold), then an existing proxy or representative (or a derivation thereof) is used to represent the new key tensor and the new value tensor. If all distances crosses the threshold (e.g., the distances are all greater than the threshold), then the new key tensor and the new value tensor may become a new cluster and be used as the proxy or representative of the new cluster.

Token importance checker 810 may determine/evaluate whether a token is important or not. The token may be a part of a request to a neural network, such as transformer-based neural network. Token importance checker 810 may determine that a token is important, based on an importance score or importance of the token. Token importance checker 810 may determine that a token is (otherwise) unimportant, based on an importance score or importance of the token. Token importance checker 810 may determine the importance score or importance of a token based on an attention weight or other metrics associated with the token.

The attention mechanism as executed by compute core 702, as illustrated in FIGS. 5-6, operates to determine an attention weight matrix based on the query tensors and key tensors corresponding to different tokens. The attention weight matrix may be arranged to have rows corresponding to different query tokens and columns corresponding to different key tokens (or columns corresponding to different query tokens and rows corresponding to different key tokens). Referring to equation 1, the attention weight matrix can include the result of computing QK^{T}/dₖ, SoftMax(QK^{T}/dₖ), or a derivation thereof. Token importance checker 810 can leverage the calculated attention weight matrix to determine the attention weight corresponding to a particular token. The attention weight may offer an indication for the particular token's contribution/importance to the attention mechanism, or how much attention the attention mechanism is paying to the particular token. In some cases, the contribution/importance (or an attention weight corresponding to a particular token) may be biased inversely to a distance of the particular token to the current token being processed. Token importance checker 810 may determine whether a token is an important token or an unimportant token based on the attention weight of the token. In some embodiments, determining whether a token is important or unimportant comprises comparing an attention weight corresponding to the token against a threshold. The threshold can be a hyperparameter that is set based on a probability distribution of attention weights. The threshold may be set to classify a certain percentage of tokens as important, and a certain percentage of tokens as unimportant. The token may be determined as important in response to the attention weight crossing or exceeding the threshold. The token may be determined as unimportant in response to the attention weight being less than the threshold.

In response to token importance checker 810 determining that a token is important, retain KV tensors 812 may retain one or more key tensors and one or more value tensors corresponding to the important token. The one or more key tensors and the one or more value tensors may be calculated by an attention head of a neural network. Retain KV tensors 812 may store key tensor(s) and value tensor(s) corresponding to the important token in a memory to retain the important token. The memory may be designated by clustering-level assignment 806 as a memory that corresponds to the important tokens. The key tensor(s) and value tensor(s) corresponding to the important token can be provided from the memory to a computing processor when the computing processor is generating one or more further tokens to facilitate reuse.

In response to token importance checker 810 determining that a token is unimportant, one or more key tensors and one or more value tensors corresponding to the unimportant token are pruned by utilizing one or more proxy key tensors and one or more proxy value tensors as proxies or representatives instead of the originally computed key tensors and value tensors. The key tensors and value tensors corresponding to the unimportant token may be evicted or dropped.

After determining that a token is unimportant, the next operation is to determine the clustering-level, which proxy to use for the unimportant token, or from which memory in the memories to obtain the proxy.

In one implementation, the technical task is to select proxy key tensors and value tensors from the shallower cache levels (faster memories). Only if the proxy is not sufficiently close, should subsequent (or lower/deeper) cache levels be accessed (slower memories). To find the proxy key tensor(s) and the proxy value tensor(s) for a given token, it is possible to first visit the coarsest granularity clustering-level first and keep visiting the subsequent finer granularity clustering-level until the proxy (e.g., a chosen centroid within a clustering-level) is sufficiently close. This implementation can optimize or aim to improve average access latency without compromising on the accuracy of the model.

Scanning the clustering-levels to find the most accurate proxy to use can have a significant impact on inference latency. In a different implementation, the scanning clustering-levels or shallower caches to reach a specific clustering-level or memory is avoided or eliminated. Instead, the search for or determination of the clustering-level is optimized by mapping (all) the tokens belonging to an attention head within a layer to a clustering-level based on a significance score of the attention head. An attention head of a neural network may calculate or process a key tensor and a value tensor corresponding to the unimportant token. Head significance score calculator 814 may calculate a significance score of the attention head. The significance score can be calculated by head significance score calculator 814 based on a similarity between the input and output of the attention head, such as a cosine similarity of the input and output of the attention head. Rather than performing a step-by-step search for the clustering-level, the significance score of the attention head dictates which memory stores the proxy, which proxy is used, or which clustering-level to use for the proxy.

In some embodiments, head significance score calculator 814 may calculate the significance score by computing a cosine similarity between an input to the attention head and an output of the attention head. Cosine similarity can be calculated using the following equation:

$$cosine similarity = ( I \cdot O ) / ( ‖ I ‖ \times ‖ O ‖ ) \qquad ( eq . 3 )$$

I is the input (vector) to the attention head. O is the output (vector) to the attention head. I·0 is the dot product of the input to the attention head and the output of the attention head, and ∥A∥ and ∥B∥ are the magnitudes (lengths) of the vectors. The input of the attention head can be substituted into I in equation 3 and the output of the attention head can be substituted into O in equation 3. In some cases, head significance score calculator 814 may determine one or more other metrics for similarity, such as Euclidean distance, Manhattan distance (or L1 distance), Pearson correlation, Jaccard similarity, etc.

In some cases, I corresponds to Q in equation 1, and O corresponds to Attention(Q, K, V) in equation 1. Cosine similarity may compare two vectors of the same size, and Q and Attention(Q, K, V) can be vectors of the same size. Phrased differently, the cosine similarity measures the input and output of the attention head.

Significance score to clustering-level mapper 816 may select or determine (or be used to select or determine) a clustering-level from a plurality of different clustering-levels for the attention head based on the significance score determined by head significance score calculator 814. The different clustering-levels can correspond to different ranges or sub-ranges of significance scores. Low similarity can indicate that the output of the attention head is significantly different from the input of the attention head. Low similarity may indicate that the computations carried out by the attention head are significant or may have a significant contribution to the accuracy of the neural network. For this reason, significance score to clustering-level mapper 816 can map attention heads with low similarity scores to fine granularity clustering-level to prevent meaningful accuracy loss. Significance score to clustering-level mapper 816 can map attention heads with high similarity scores to a coarse granularity clustering-level.

A given clustering-level can correspond to a sub-range of significance scores. Different clustering-levels can correspond to different sub-ranges of significance scores. Significance score clustering-level mapper 816 can determine the clustering-level by determining that the significance score falls within the sub-range of significance scores. In one example, the mapping of ranges of significance scores to different clustering-levels is as follows:

| Range of Significance Score | |
|---|---|
| (0 < S1 < S2 < S3 . . . < SC − 1 < SC) | Clustering-level |
| 0 ≤ significance score ≤ S1 | Clustering-level 1 |
| | (coarsest granularity) |
| S1 < significance score ≤ S2 | Clustering-level 2 |
| S2 < significance score ≤ S3 | Clustering-level 3 |
| . . . | . . . |
| SC − 1 < significance score ≤ SC | Clustering-level C |
| | (finest granularity) |

In one example, an attention head having a low similarity or high significance score may be mapped to clustering-level C. An attention head having a moderate similarity or moderate significance score may be mapped to clustering-level C-1. An attention head having a high similarity or low significance score may be mapped to clustering-level 1. Clustering-level 1 may be the coarsest granularity clustering-level. Clustering-level 2 may be a finer granularity clustering-level. Clustering-level C may be the finest granularity clustering-level.

Advantageously, the mapping (e.g., how the sub-ranges are defined) can be a tunable design knob that can be adjusted to balance latency and accuracy.

Use proxy at clustering-level 818 can serve or provide the proxy key tensor and the proxy value tensor corresponding to an unimportant token, from a memory that corresponds to the clustering-level determined by clustering-level mapper 816. The proxy key tensor and the proxy value tensor can be (reused) by a computing processor carrying out operations for an attention head that is mapped to the clustering-level to generate the next token. By serving or providing the proxy from the memory of a specific clustering-level mapped to the significance score of a given attention head, the accuracy loss resulting from token pruning is mitigated by using proxies generated at a coarser granularity for less significant attention heads, and using proxies generated at a finer granularity for more significant attention heads.

### Methods for KV Cache Compression

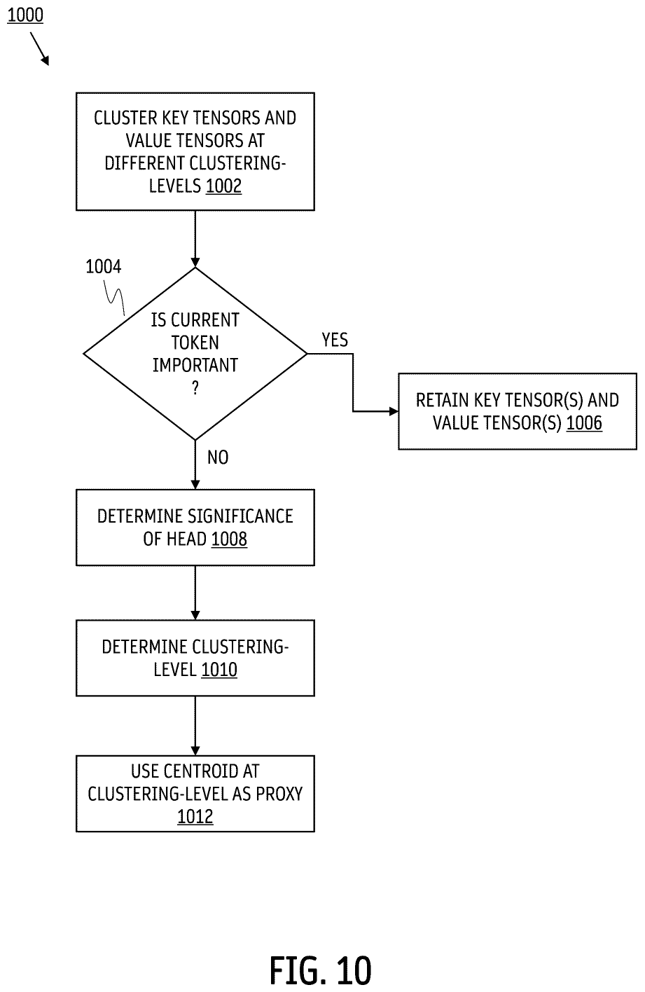

FIG. 10 is a flowchart illustrating KV cache retention and approximation using proxies, according to some embodiments of the disclosure. Method 1000 can be implemented to provide a multi-granular clustering-based solution. Method 1000 can be performed using a computing device, such as computing device 1300 in FIG. 13.

In 1002, an input prompt to a transformer-based neural network may be processed. Key tensors and value tensors produced for tokens of the input prompt can be clustered at different clustering-levels. Method 1000 may proceed to current token processing.

In 1004, a determination is made whether the current token is important or not. Whether the current token is important or not can be determined based on the importance of the token. If a current token is important, the current token is not pruned. If a current token is unimportant, the current token is to be pruned, e.g., where the key tensors and value tensors calculated for the current token are not stored in the KV cache, rather proxy key tensors and proxy value tensors are stored in the KV cache. Whether the current token is important or not can be determined based on the attention weight of the token. If the attention weight is greater than or equal to a threshold, then the token is important. If the attention weight is less than the threshold, then the token is not important, or unimportant. If the token is important, method 1000 may proceed to 1006. If the token is unimportant, method 1000 may proceed to 1008.

In 1006, the important token is retained. Key tensor(s) and value tensor(s) corresponding to the important token is retained or stored in a memory designated to store/cache key tensors and value tensors for important tokens.

In 1008, the unimportant token is pruned, and a proxy is to be used for the unimportant token. The significance or significance score of an attention head that produced a key tensor and a value tensor corresponding to an unimportant token can be determined.

In 1010, based on the significance score, the clustering-level for the attention head is determined. The clustering-level for the attention head can be determined using a mapping between sub-ranges of significance scores to different clustering-levels.

In 1012, a centroid or representative at the clustering-level can be used as a proxy key tensor and/or a proxy value tensor for the unimportant token. The proxy key tensor and/or the proxy value tensor can be used in computations to be performed by the attention head when generating the next token.

For unimportant tokens, 1008, 1010, and 1012 represent a process for determining which clustering-level to retrieve the proxy for a given attention head. A transformer-based neural network may have many attention layers and within each attention layer can include one or more attention heads. The significance scores of the various attention heads in a layer or across layers can differ. This means that proxies produced at varying clustering-levels can be used for attention heads with different significance scores to balance latency and accuracy.

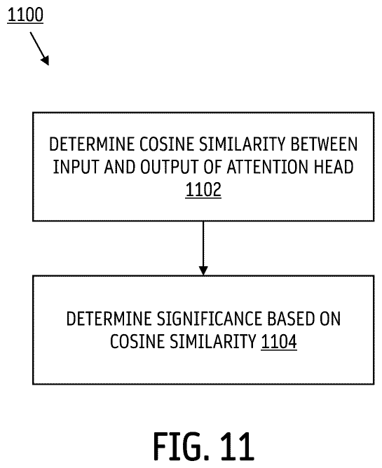

FIG. 11 is a flow chart illustrating determination of significance of an attention head, according to some embodiments of the disclosure. Method 1100 illustrates operations for 1008 of method 1000. Method 1100 can be performed using a computing device, such as computing device 1300 in FIG. 13.

In 1102, a cosine similarity between the input tensor to an attention head and the output tensor of the attention head is determined. The input tensor to an attention head may include the query tensor. The output tensor of the attention head may include the output matrix of attention weights weighted by the value tensor (e.g., a result from calculating equation 1).

In 1104, the significance or significance score of the attention head may be determined based on the cosine similarity. In some cases, the significance score is the cosine similarity. In some cases, the significance score is a cosine similarity that is normalized across all attention heads.

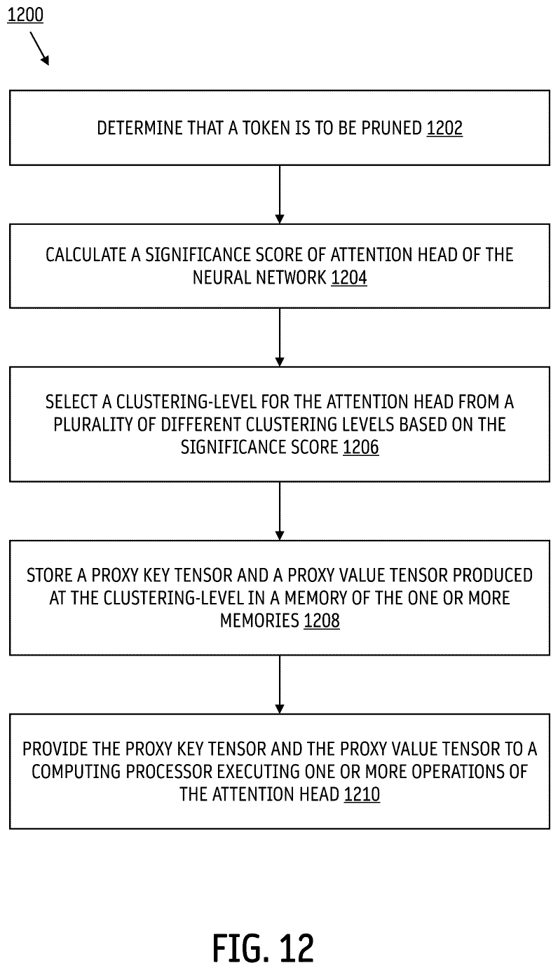

FIG. 12 is a flowchart illustrating a method for KV caching with multi-granular clustering-based approximation of KV caches associated with unimportant tokens, according to some embodiments of the disclosure. Method 1200 can be performed using a computing device, such as computing device 1300 in FIG. 13.

In 1202, a token may be determined to be unimportant. A token may be determined to be pruned. The token is a part of a request to a neural network, such as a transformer-based neural network, or a neural network having an attention mechanism.

In 1204, a significance score of an attention head of the neural network is calculated.

In 1206, a clustering-level is selected from a plurality of different clustering-levels for the attention head based on the significance score.

In 1208, a proxy key tensor and a proxy value tensor produced at the clustering-level is stored in a memory of one or more memories. The one or more memories may store data at different clustering-levels. The data may include data for a KV cache. There may be multiple memories corresponding to different clustering-levels. The proxy key tensor and the proxy value tensor may represent a key tensor and a value tensor calculated by the attention head for the token. For example, the proxy key tensor and the proxy value tensor may approximate a key tensor and a value tensor calculated by the attention head for the token.

In 1210, the proxy key tensor and the proxy value tensor are provided to a computing logic executing one or more operations of the attention head. The proxy key tensor and the proxy value tensor can be used by the computing processor to carry out the operations of the attention head. The proxy key tensor and the proxy value tensor facilitates reuse of key tensors and value tensors by offering an approximation of the key tensors and value tensors and avoid redundant computations in the attention head when producing a next token.

### Exemplary Computing Device

FIG. 13 is a block diagram of an apparatus or a system, e.g., an exemplary computing device 1300, according to some embodiments of the disclosure. One or more computing devices 1300 may be used to implement the functionalities described with the FIGS. and herein. A number of components illustrated in FIG. 13 can be included in the computing device 1300, but any one or more of these components may be omitted or duplicated, as suitable for the application. In some embodiments, some or all of the components included in computing device 1300 may be attached to one or more motherboards. In some embodiments, some or all of these components are fabricated onto a single system on a chip (SoC) die. Additionally, in various embodiments, computing device 1300 may not include one or more of the components illustrated in FIG. 13, and computing device 1300 may include interface circuitry for coupling to the one or more components. For example, the computing device 1300 may not include display device 1306, and may include display device interface circuitry (e.g., a connector and driver circuitry) to which a display device 1306 may be coupled. In another set of examples, computing device 1300 may not include audio input device 1318 or an audio output device 1308 and may include audio input or output device interface circuitry (e.g., connectors and supporting circuitry) to which an audio input device 1318 or audio output device 1308 may be coupled.

Computing device 1300 may include processing device 1302 (e.g., one or more processing devices, one or more of the same types of processing device, one or more of different types of processing device). Processing device 1302 may include electronic circuitry that process electronic data from data storage elements (e.g., registers, memory, resistors, capacitors, quantum bit cells) to transform that electronic data into other electronic data that may be stored in registers and/or memory. Examples of processing device 1302 may include a CPU, a GPU, a quantum processor, a machine learning processor, an artificial intelligence processor, a neural network processor, a neural processing unit (NPU), an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

The computing device 1300 may include a memory 1304, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1304 includes one or more non-transitory computer-readable storage media. In some embodiments, memory 1304 may include memory that shares a die with the processing device 1302.

In some embodiments, memory 1304 includes one or more non-transitory computer-readable media storing instructions executable to perform operations described with the FIGS. and herein, such as the methods and operations illustrated in the FIGS. In some embodiments, memory 1304 includes one or more non-transitory computer-readable media storing instructions executable to perform operations of method 1000 of FIG. 10, method 1100 of FIG. 11, and method 1200 of FIG. 12. Exemplary parts that may be encoded as instructions and stored in memory 1304 are depicted. Memory 1304 may store instructions that encode one or more exemplary parts, such as cache controller 802. The instructions stored in the one or more non-transitory computer-readable media may be executed by processing device 1302.

In some embodiments, memory 1304 may store data, e.g., data structures, binary data, bits, metadata, files, blobs, etc., as described with the FIGS. and herein. For example, memory 1304 may store key tokens and value tokens. Memory 1304 may store proxy key tokens and proxy value tokens. Memory 1304 may store importance scores of tokens. Memory 1304 may store significance scores of attention heads.

In some embodiments, the computing device 1300 may include a communication device 1312 (e.g., one or more communication devices). For example, the communication device 1312 may be configured for managing wired and/or wireless communications for the transfer of data to and from the computing device 1300. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1312 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1312 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1312 may operate in accordance with other wireless protocols in other embodiments. The computing device 1300 may include an antenna 1322 to facilitate wireless communications and/or to receive other wireless communications (such as radio frequency transmissions). The computing device 1300 may include receiver circuits and/or transmitter circuits. In some embodiments, the communication device 1312 may manage wired communications, such as electrical, optical, or any other suitable communication protocols (e.g., the Ethernet). As noted above, the communication device 1312 may include multiple communication chips. For instance, a first communication device 1312 may be dedicated to shorter-range wireless communications such as Wi-Fi or Bluetooth, and a second communication device 1312 may be dedicated to longer-range wireless communications such as global positioning system (GPS), EDGE, GPRS, CDMA, WiMAX, LTE, EV-DO, or others. In some embodiments, a first communication device 1312 may be dedicated to wireless communications, and a second communication device 1312 may be dedicated to wired communications.

The computing device 1300 may include power source/power circuitry 1314. The power source/power circuitry 1314 may include one or more energy storage devices (e.g., batteries or capacitors) and/or circuitry for coupling components of the computing device 1300 to an energy source separate from the computing device 1300 (e.g., DC power, AC power, etc.).

The computing device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

The computing device 1300 may include an audio output device 1308 (or corresponding interface circuitry, as discussed above). The audio output device 1308 may include any device that generates an audible indicator, such as speakers, headsets, or earbuds, for example.

The computing device 1300 may include an audio input device 1318 (or corresponding interface circuitry, as discussed above). The audio input device 1318 may include any device that generates a signal representative of a sound, such as microphones, microphone arrays, or digital instruments (e.g., instruments having a musical instrument digital interface (MIDI) output).

The computing device 1300 may include a GPS device 1316 (or corresponding interface circuitry, as discussed above). The GPS device 1316 may be in communication with a satellite-based system and may receive a location of the computing device 1300, as known in the art.

The computing device 1300 may include a sensor 1330 (or one or more sensors). The computing device 1300 may include corresponding interface circuitry, as discussed above). Sensor 1330 may sense physical phenomenon and translate the physical phenomenon into electrical signals that can be processed by, e.g., processing device 1302. Examples of sensor 1330 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1300 may include another output device 1310 (or corresponding interface circuitry, as discussed above). Examples of the other output device 1310 may include an audio codec, a video codec, a printer, a wired or wireless transmitter for providing information to other devices, haptic output device, gas output device, vibrational output device, lighting output device, home automation controller, or an additional storage device.

The computing device 1300 may include another input device 1320 (or corresponding interface circuitry, as discussed above). Examples of the other input device 1320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1300 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1300 may be any other electronic device that processes data.

### SELECT EXAMPLES

Example 1 provides an apparatus including at least one computer processor; and one or more memories storing data at different clustering-levels and instructions; where the at least one computer processor, when executing the instructions, is to: determine that a token is to be pruned based on an importance of the token, the token being a part of a request to a neural network; calculate a significance score of an attention head of the neural network; select a clustering-level for the attention head from different clustering-levels based on the significance score; store a proxy key tensor and a proxy value tensor produced at the clustering-level in a memory of the one or more memories, the proxy key tensor and the proxy value tensor representing a key tensor and a value tensor calculated by the attention head for the token; and provide the proxy key tensor and the proxy value tensor to computing logic that is executing one or more operations of the attention head.

Example 2 provides the apparatus of example 1, where the proxy key tensor and the proxy value tensor are an approximation of the key tensor and the value tensor.

Example 3 provides the apparatus of example 1 or 2, where the at least one computer processor is further to: determine that a further token is important, the token being a further part of the request; store a further key tensor and a further value tensor calculated by the attention head for the further token in a further memory of the one or more memories; and provide the further key tensor and the further value tensor to the computing logic.

Example 4 provides the apparatus of any one of examples 1-3, where determining that the token is to be pruned includes comparing an attention weight corresponding to the token against a threshold.

Example 5 provides the apparatus of any one of examples 1-4, where calculating the significance score of the attention head includes computing a cosine similarity between an input to the attention head and an output of the attention head.

Example 6 provides the apparatus of any one of examples 1-5, where the different clustering-levels correspond to different ranges of significance scores.

Example 7 provides the apparatus of any one of examples 1-6, where: the clustering-level correspond to a sub-range of significance scores; and determining the clustering-level includes determining that the significance score falls within the sub-range of significance scores.

Example 8 provides the apparatus of any one of examples 1-7, where the at least one computer processor is further to: cluster one or more key tensors and one or more value tensors calculated by the attention head according to the different clustering-levels; and determine the proxy key tensor and the proxy value tensor based on one or more centroids of one or more clusters at the clustering-level.

Example 9 provides one or more non-transitory computer-readable media storing instructions executable by a processor to perform operations for memory management, the operations including determining that a token is to be pruned based on an importance of the token, the token being a part of a request to a neural network; calculating a significance score of an attention head of the neural network; selecting a clustering-level for the attention head from different clustering-levels based on the significance score; store a proxy key tensor and a proxy value tensor produced at the clustering-level in a memory of one or more memories, the proxy key tensor and the proxy value tensor representing a key tensor and a value tensor calculated by the attention head for the token and the one or more memories store data at the different clustering-levels; and provide the proxy key tensor and the proxy value tensor to computing logic that is executing one or more operations of the attention head.

Example 10 provides the one or more non-transitory computer-readable media of example 9, where the proxy key tensor and the proxy value tensor are an approximation of the key tensor and the value tensor.

Example 11 provides the one or more non-transitory computer-readable media of example 9 or 10, where the operations further include: determining that a further token is important, the token being a further part of the request; storing a further key tensor and a further value tensor calculated by the attention head in a further memory of the one or more memories; and providing the further key tensor and the further value tensor to the computing logic.

Example 12 provides the one or more non-transitory computer-readable media of any one of examples 9-11, where determining that the token is to be pruned includes comparing an attention weight corresponding to the token against a threshold.

Example 13 provides the one or more non-transitory computer-readable media of any one of examples 9-12, where calculating the significance score of the attention head includes computing a cosine similarity between an input to the attention head and an output of the attention head.

Example 14 provides the one or more non-transitory computer-readable media of any one of examples 9-13, where the different clustering-levels correspond to different ranges of significance scores.

Example 15 provides the one or more non-transitory computer-readable media of any one of examples 9-14, where: the clustering-level correspond to a sub-range of significance scores; and determining the clustering-level includes determining that the significance score falls within the sub-range of significance scores.

Example 16 provides the one or more non-transitory computer-readable media of any one of examples 9-15, where the operations further include: clustering one or more key tensors and one or more value tensors according to the different clustering-levels; and determining the proxy key tensor and the proxy value tensor based on one or more centroids of one or more clusters at the clustering-level.

Example 17 provides a method, including determining that a token is to be pruned based on an importance of the token, the token being a part of a request to a neural network; calculating a significance score of an attention head of the neural network; selecting a clustering-level for the attention head from different clustering-levels based on the significance score; store a proxy key tensor and a proxy value tensor produced at the clustering-level in a memory of one or more memories, the proxy key tensor and the proxy value tensor representing a key tensor and a value tensor calculated by the attention head for the token and the one or more memories store data at the different clustering-levels; and provide the proxy key tensor and the proxy value tensor to computing logic that is executing one or more operations of the attention head.

Example 18 provides the method of example 17, where the proxy key tensor and the proxy value tensor are an approximation of the key tensor and the value tensor.

Example 19 provides the method of example 17 or 18, further including determining that a further token is important, the token being a further part of the request; storing a further key tensor and a further value tensor calculated by the attention head in a further memory of the one or more memories; and providing the further key tensor and the further value tensor to the computing logic.

Example 20 provides the method of any one of examples 17-19, where determining that the token is to be pruned includes comparing an attention weight corresponding to the token against a threshold.

Example 21 provides the method of any one of examples 17-20, where calculating the significance score of the attention head includes computing a cosine similarity between an input to the attention head and an output of the attention head.

Example 22 provides the method of any one of examples 17-21, where the different clustering-levels correspond to different ranges of significance scores.

Example 23 provides the method of any one of examples 17-22, where: the clustering-level correspond to a sub-range of significance scores; and determining the clustering-level includes determining that the significance score falls within the sub-range of significance scores.

Example 24 provides the method of any one of examples 17-23, further including clustering one or more key tensors and one or more value tensors according to the different clustering-levels; and determining the proxy key tensor and the proxy value tensor based on one or more centroids of one or more clusters at the clustering-level.

Example A includes an apparatus comprising means to perform any one of the methods in examples 17-24.

Example B includes a cache controller as described herein.

Example C includes a computing system having a compute core, memories, and a cache controller as described herein (such as in FIG. 8).

### Variations and Other Notes

Although the operations of the example method shown in and described with reference to FIGS. 10-12 are illustrated as occurring once each and in a particular order, it will be recognized that the operations may be performed in any suitable order and repeated as desired. Additionally, one or more operations may be performed in parallel. Furthermore, the operations illustrated in FIGS. 10-12 may be combined or may include more or fewer details than described.

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus comprising:
at least one computer processor; and
one or more memories storing data at different clustering-levels and instructions;
wherein the at least one computer processor, when executing the instructions, is to:
determine that a token is to be pruned based on an importance of the token, the token being a part of a request to a neural network;
calculate a significance score of an attention head of the neural network;
select a clustering-level for the attention head from different clustering-levels based on the significance score;
store a proxy key tensor and a proxy value tensor produced at the clustering-level in a memory of the one or more memories, the proxy key tensor and the proxy value tensor representing a key tensor and a value tensor calculated by the attention head for the token; and
provide the proxy key tensor and the proxy value tensor to computing logic that is executing one or more operations of the attention head.

2. The apparatus of claim 1, wherein the proxy key tensor and the proxy value tensor are an approximation of the key tensor and the value tensor.

3. The apparatus of claim 1 wherein the at least one computer processor is further to:
determine that a further token is important, the token being a further part of the request;
store a further key tensor and a further value tensor calculated by the attention head for the further token in a further memory of the one or more memories; and
provide the further key tensor and the further value tensor to the computing logic.

4. The apparatus of claim 1, wherein determining that the token is to be pruned comprises:
comparing an attention weight corresponding to the token against a threshold.

5. The apparatus of claim 1, wherein calculating the significance score of the attention head comprises:
computing a cosine similarity between an input to the attention head and an output of the attention head.

6. The apparatus of claim 1, wherein the different clustering-levels correspond to different ranges of significance scores.

7. The apparatus of claim 1, wherein:
the clustering-level correspond to a sub-range of significance scores; and
determining the clustering-level comprises determining that the significance score falls within the sub-range of significance scores.

8. The apparatus of claim 1, wherein the at least one computer processor is further to:
cluster one or more key tensors and one or more value tensors according to the different clustering-levels; and
determine the proxy key tensor and the proxy value tensor based on one or more centroids of one or more clusters at the clustering-level.

9. One or more non-transitory computer-readable media storing instructions executable by a processor to perform operations for memory management, the operations comprising:
determining that a token is to be pruned based on an importance of the token, the token being a part of a request to a neural network;
calculating a significance score of an attention head of the neural network;
selecting a clustering-level for the attention head from different clustering-levels based on the significance score;
store a proxy key tensor and a proxy value tensor produced at the clustering-level in a memory of one or more memories, the proxy key tensor and the proxy value tensor representing a key tensor and a value tensor calculated by the attention head for the token and the one or more memories store data at the different clustering-levels; and
provide the proxy key tensor and the proxy value tensor to computing logic that is executing one or more operations of the attention head.

10. The one or more non-transitory computer-readable media of claim 9, wherein the operations further include:
determining that a further token is important, the token being a further part of the request;
storing a further key tensor and a further value tensor calculated by the attention head in a further memory of the one or more memories; and
providing the further key tensor and the further value tensor to the computing logic.

11. The one or more non-transitory computer-readable media of claim 9, wherein calculating the significance score of the attention head comprises:
computing a cosine similarity between an input to the attention head and an output of the attention head.

12. The one or more non-transitory computer-readable media of claim 9, wherein the different clustering-levels correspond to different ranges of significance scores.

13. The one or more non-transitory computer-readable media of claim 9, wherein:
the clustering-level correspond to a sub-range of significance scores; and
determining the clustering-level comprises determining that the significance score falls within the sub-range of significance scores.

14. The one or more non-transitory computer-readable media of claim 9, wherein the operations further include:
clustering one or more key tensors and one or more value tensors according to the different clustering-levels; and
determining the proxy key tensor and the proxy value tensor based on one or more centroids of one or more clusters at the clustering-level.

15. A method, comprising:
determining that a token is to be pruned based on an importance of the token, the token being a part of a request to a neural network;
calculating a significance score of an attention head of the neural network;
selecting a clustering-level for the attention head from different clustering-levels based on the significance score;
store a proxy key tensor and a proxy value tensor produced at the clustering-level in a memory of one or more memories, the proxy key tensor and the proxy value tensor representing a key tensor and a value tensor calculated by the attention head for the token and the one or more memories store data at the different clustering-levels; and
provide the proxy key tensor and the proxy value tensor to computing logic that is executing one or more operations of the attention head.

16. The method of claim 15, further comprising:
determining that a further token is important, the token being a further part of the request;
storing a further key tensor and a further value tensor calculated by the attention head in a further memory of the one or more memories; and
providing the further key tensor and the further value tensor to the computing logic.

17. The method of claim 15, wherein determining that the token is to be pruned comprises:
comparing an attention weight corresponding to the token against a threshold.

18. The method of claim 15, wherein calculating the significance score of the attention head comprises:
computing a cosine similarity between an input to the attention head and an output of the attention head.

19. The method of claim 15, wherein:
the clustering-level correspond to a sub-range of significance scores; and
determining the clustering-level comprises determining that the significance score falls within the sub-range of significance scores.

20. The method of claim 15, further comprising:
clustering one or more key tensors and one or more value tensors according to the different clustering-levels; and
determining the proxy key tensor and the proxy value tensor based on one or more centroids of one or more clusters at the clustering-level.
